(19) United States
(12) Patent Application Publication
(10) Pub. No.: US 2024/0092391 A1
(43) Pub. Date: Mar. 21, 2024

(54) METHOD FOR IMPROVING SAFETY PRECAUTIONS FOR VEHICLES MOVING IN AN AT LEAST PARTIALLY AUTOMATED MANNER

(71) Applicant: Robert Bosch GmbH, Stuttgart (DE)

(72) Inventors: Farzaneh Ghanbari Milani, Korntal-Muenchingen (DE); Peter Munk, Renningen (DE)

(21) Appl. No.: 18/464,816

(22) Filed: Sep. 11, 2023

(30) Foreign Application Priority Data
Sep. 16, 2022 (DE) 10 2022 209 782.3

(51) Int. Cl. B60W 60/00; B60W 50/02

(52) U.S. Cl. CPC B60W 60/0015; B60W 50/0205; B60W 2420/42; B60W 2420/52; B60W 2520/00; B60W 2552/05; B60W 2555/20

(57) ABSTRACT

A method for improving safety precautions for vehicles. The method includes: obtaining, from one or from each of a plurality of vehicles moving in an at least partially automated manner, if a safety metric is fulfilled at a time point in the vehicle, scenario information and safety metric information; determining a relevance distribution of at least one safety metric of the scenario present at that time point, which indicates how often a respective safety metric is or has been fulfilled in that scenario; comparing the determined relevance distribution to relevance distributions of at least one already existing scenarios; determining the scenario to be a potential trigger event if the relevance distribution of the scenario present at that time point matches a relevance distribution of at least one already existing scenario for which a trigger event is defined; and providing information about the potential trigger event.

### FIELD

The present invention relates to methods for improving safety precautions for vehicles moving in an at least partially automated manner, and to a computing unit and a computer program for carrying them out.

### BACKGROUND INFORMATION

In various areas, vehicles that move in an at least partially or even fully automated manner can be used. For example, vehicles for passenger and goods transportation on the road are becoming more and more automated, all the way to an autonomously driving vehicle. However, vehicles moving in an at least partially automated manner are, for example, also used in factory or plant environments, for example also as robots. Depending on the application area and/or the application, the use of such vehicles can be safety-critical. For example, the safety of persons within and in the environment of such a vehicle must be ensured at all time points.

### SUMMARY

According to the present invention, methods for improving safety precautions for vehicles moving in an at least partially automated manner, as well as a computing unit and a computer program for carrying them out are provided. Advantageous embodiments of the present invention are disclosed herein.

The present invention relates to vehicles moving in an at least partially or even fully automated manner, such as vehicles for passenger and/or goods transportation on the road, in factory or plant environments, or even robots. As mentioned, the use of such vehicles can be safety-critical depending on the application area and/or application.

In particular, the present invention relates to improving (or increasing) safety precautions for vehicles moving in an at least partially automated manner, viz, based on trigger events and safety metrics. A trigger event is to define one or more predetermined conditions for a scenario. A scenario, in turn, is to comprise values for one or more vehicle and/or environmental parameters, e.g., for road type, speed, (geographic) position, time of day, weather, recognized objects (e.g., in front of the vehicle). The vehicle and/or environmental parameters of the scenario can in this case be detectable, for example, at least partially by means of one or more sensors of a vehicle moving in an at least partially automated manner. A trigger event thus specifies, for example, specific values for different vehicle and/or environmental parameters in which a trigger event is deemed to be fulfilled. In this way, it can thus, for example, be recognized in a vehicle whether a (possibly potentially) safety-critical situation exists, and measures, e.g., braking of the vehicle, can, for example, be taken if necessary.

A safety metric can define a first metric that, in a vehicle moving in an at least partially automated manner, during operation of the vehicle, determines values for one or more vehicle and/or environmental parameters (or measures them; this can be the same and/or different or further vehicle and/or environmental parameters than for the scenario) and compares them to one or more threshold values (e.g., upper and/or lower threshold value). The safety metric is deemed to be fulfilled if at least one of the values of the first metric exceeds or falls below the one or at least one of the plurality of threshold values. In this context, the safety metrics are also referred to as so-called continuous safety metrics. There are also so-called Boolean safety metrics, which can only be true or false, for example. In this case, a safety metric can define a second metric that checks whether one or more predetermined states exist, wherein the safety metric is deemed to be fulfilled if the one or at least one of the plurality of predetermined states exists. Such a state may comprise, for example, whether a fallback level is activated or not.

In particular, the ISO 21448 standard is also used in this case. This standard defines, for example, a so-called operational design domain (ODD) as any possible conditions, applications, constraints, and situations that an autonomous system or vehicle, or an autonomous function thereof, can safely handle without driver (or user) intervention. Typical ODD factors include time of day, weather, traffic, and road conditions. In order to release the application of an autonomous system or vehicle (or the function thereof), limits of the ODD or of ODD factors must be defined, which must be given for a correct automated function. Limits can be, for example, that the automated function considered is allowed only in daylight (limit based on the ODD factor “time of day”) and dry weather (limit for ODD factor “weather” or “road condition”) because, for example, video-based sensor technology is used. A function may, for example, also be allowed only on highways (limit for ODD factor “road type”).

ISO 21448 defines a scene, e.g., as a characteristic of the ODD at a fixed time point, e.g., at a given time point, in rain with a lot of traffic on a highway with a curve radius of 3° and outside a tunnel. A scenario, on the other hand, is a description of the temporal development between a plurality of scenes.

ISO 21448 also defines a so-called triggering condition (trigger event) as specific conditions of a scenario in which the safe behavior of the system or of the vehicle within ODD is potentially at risk even without the existence of internal faults, i.e., for example, when exiting a tunnel against the lights with a subsequent sharp turn. If these triggering conditions are known, the system or the vehicle can be designed such that safe operation even in these situations continues to be ensured. In order to recognize and evaluate the potential triggering conditions, various scenarios must be reconstructed based on the triggering factors, such as weather condition, time of day, road profile, and other road users. The mentioned trigger event may, in particular, be or comprise such a triggering condition.

In the UL4600 standard, a so-called safety performance indicator (SPI) is defined as a safety-related metric that is determined or measured in the vehicle at run time point, i.e., during operation. Such an SPI is, for example, the time to collision (TTC), i.e., a time up to a (hypothetical) collision with an obstacle, which time is continuously ascertained in the vehicle in order to derive driving actions therefrom. For example, if a particular TTC is fallen below, a corresponding braking operation is initiated. One or more (additional) threshold values can now also be defined for each SPI, relevant vehicle and environmental data being sent to an evaluation system or an evaluation site, such as a server, when said threshold values are exceeded or fallen below. The mentioned safety metric may, in particular, be or comprise such an SPI, in particular with one or more such threshold values. Further examples of SPI include the brake threat number (BTN) or the steering threat number (STN). Both metrics are based on vehicle acceleration.

The STN assesses the risk of a steering maneuver for collision avoidance, while the BTN assesses the risk of a braking maneuver for avoiding a collision. Additionally, in-vehicle metrics, e.g., the correct classification of objects in a camera path or the frequency of triggering a safety mechanism, may be used as SPI.

In particular but not only with vehicles moving in an at least partially automated manner in complex environments, such as road traffic, many different trigger events are possible and also necessary to be able to cover as many safety-critical situations as possible or all safety-critical situations. However, as has been found, it is difficult to list all or sufficiently many trigger events, in particular also in full, i.e., with all relevant conditions. New or previously unknown potential trigger events can now be determined in the context of the present invention.

For this purpose, if a safety metric is fulfilled in the vehicle at a time point, scenario information and safety metric information are obtained, e.g., in an evaluation system at an evaluation site or in a server or another computing unit there, from one or from each of a plurality of vehicles moving in at least partially automated manner. In this case, the fulfilled safety metric may be one with the first metric or with the second metric. It is understood that a plurality of safety metrics may also be fulfilled simultaneously.

The scenario information characterizes a scenario present at that time point. The scenario information can comprise the scenario itself, i.e., the scenario can, for example, be determined or ascertained directly in the vehicle or an executing computing unit, namely, for example, based on operating data of the vehicle present and/or detected at the time point. For example, for at least one, preferably each, sensor of the vehicle, such operating data may comprise the current sensor data, e.g., a recorded video or radar data, or also internal states of the vehicle, e.g., a recognized environment.

Likewise, the scenario information may comprise operating data of the vehicle present and/or detected at the time point. The scenario present at that time point can then, for example, be determined (i.e., e.g., reconstructed) at the evaluation site at least partially based on the operating data. This can take place at an evaluation site, e.g., with higher computing power and/or better algorithms, possibly also further additional information.

The safety metric information comprises current information on the fulfilled safety metric and preferably at least one further, in particular all further, safety metrics of the respective vehicle, regarding at least the scenario present at that time point. In particular, all available data on the safety metrics monitored in the vehicle are thus obtained.

The scenario and safety metric information can thus be transmitted from the relevant vehicle to an evaluation system or an evaluation site, such as a server or other computing unit (also into the so-called cloud). This may in particular take place every time a safety metric is fulfilled in a vehicle.

According to an example embodiment of the present invention, it can then, for example, also be checked (in particular, automatically) whether the scenario present at that time point has already been stored, e.g., in a data store or a database at the evaluation site, i.e., whether, e.g., the same scenario (including in each case the mentioned information) has previously already been obtained one or more times. If this is not the case, the scenario present at that time point and the safety metric information can be stored, i.e., a new entry in the data store or the database can be added, for example. If this is the case, a statistic of the scenario present at that time point and already stored can be updated (in particular, automatically), i.e., the newly obtained safety metric information can be added as a new data record to the entry of the scenario.

According to an example embodiment of the present invention, a relevance distribution of at least one, preferably all safety metrics of the scenario present at that time point is then determined (in particular, automatically); this takes place, for example, based on the already existing data records for this scenario, which were amended every time a safety metric for this scenario was fulfilled. For each data record, there are therefore typically a plurality of safety metrics that may or may not be fulfilled. The relevance distribution now indicates how often (e.g., as a percentage) a particular safety metric is or has been fulfilled in this scenario. For example, a time-to-collision safety metric may have been fulfilled for 75% of all data records of the scenario.

The relevance distribution determined in this way is then compared (in particular, automatically) to relevance distributions of at least one, preferably several or all already existing scenarios (viz., now scenarios other than the scenario for which the safety metric is currently fulfilled) for which a trigger event is defined. If the relevance distribution of the scenario present at that time point matches, within predetermined limits, a relevance distribution of at least one already existing scenario for which a trigger event is defined, the scenario present at that time point is determined to be a potential trigger event. Information about the potential trigger event is then provided, e.g., for a developer who can then assess whether the potential trigger event is ultimately used as a trigger event or not.

Expediently, according to an example embodiment of the present invention, new trigger events are then automatically added to a database for future testing of vehicles moving in an at least partially automated manner. All trigger events to be checked can be stored in such a database, for example. Likewise, such new trigger events can be transmitted to the vehicles so that they are taken into account in the future. These new trigger events may, in particular, be those that were determined on the basis of the potential trigger event to be trigger events to be used.

The fact that a certain relevance distribution itself indicates or can at least indicate a certain problem or difficulty is utilized here. If a particular relevance distribution of a particular safety metric occurs in another scenario and a trigger event is defined there, the conclusion can be drawn that this also indicates a potential trigger event in the current scenario. In this case, the relevance distributions need not be identical, but a match within certain limits of, e.g., +/−5% (absolute or relative) is typically sufficient.

In the relevant vehicle itself, it is then provided accordingly that it is checked whether a safety metric is fulfilled. If a safety metric is fulfilled in the vehicle at a time point, scenario information (such as defined above) and safety metric information (such as defined above) are transmitted to an evaluation site. For this purpose, a control unit in the vehicle can, for example, be used as the executing computing unit.

According to an example embodiment of the present invention, it can preferably be provided that it is checked (in the vehicle) whether a trigger event has already been defined for the scenario present at that time point; for this purpose, corresponding comparisons can, for example, be performed, especially since trigger events are implemented in the vehicle anyway, or further trigger events can also simply be stored by means of a suitable list or the like. If a trigger event has already been defined for the scenario present at that time point, scenario information and safety metric information will not be transmitted; the method can be discontinued here since a new trigger event cannot be defined.

However, it may now be the case that scenario information and safety metric information will still be transmitted. According to an example embodiment of the present invention, in this respect, it is expedient to check, e.g., at the evaluation site, whether a trigger event has already been defined for the scenario present at that time point. If this is the case, and the information should therefore not have actually been obtained at all, the information, i.e., e.g., the scenario information and safety metric information, obtained from the respective vehicle can be provided for checking the vehicle. It can then be checked, for example, whether there is a fault in the vehicle.

It can also be provided that the faulty vehicle is automatically brought into a safe state or that a safe state is established (i.e., for example, the vehicle can be stopped in an automated manner). Moreover, a user or driver can be informed of the fault or that the vehicle is faulty. Further sensor and system self-tests may likewise be initiated, for example.

A computing unit according to the present invention, e.g., a control unit of a vehicle or a server, is configured, in particular in terms of program technology, to carry out a method according to the present invention.

The implementation of a method according to the present invention in the form of a computer program or computer program product with program code for carrying out all method steps is also advantageous since this results in particularly low costs, in particular if an executing control unit is also used for further tasks and is therefore already present. Lastly, a machine-readable storage medium is provided, on which the computer program as described above is stored. Suitable storage media or data carriers for providing the computer program are in particular magnetic, optical and electrical memories, such as hard disks, flash memories, EEPROMs, DVDs, etc. Downloading a program via computer networks (internet, intranet, etc.) is also possible. Such a download can take place in a wired, or cabled, or wireless manner (e.g., via a WLAN, a 3G, 4G, 5G, or 6G connection, etc.).

Further advantages and configurations of the present invention become apparent from the description and the figures.

The present invention is illustrated schematically in the figures on the basis of an exemplary embodiment and is described below with reference to the figures.

### BRIEF DESCRIPTION OF THE DRAWINGS

FIG. 1 schematically shows an arrangement with a plurality of vehicles for explaining an example embodiment of the present invention.

FIG. 2 schematically shows a sequence of a method according to the present invention in a preferred embodiment.

FIG. 3 schematically shows a sequence of a method according to the present invention in a further, preferred embodiment.

FIG. 4 schematically shows a sequence of a method according to the present invention in a further, preferred embodiment.

### DETAILED DESCRIPTION OF EXAMPLE EMBODIMENTS

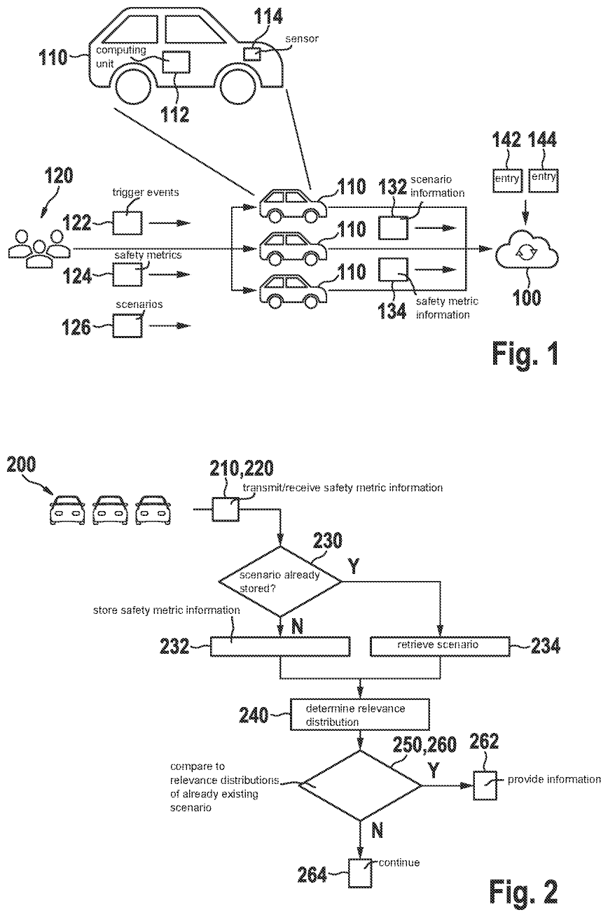

FIG. 1 schematically shows an arrangement with a plurality of vehicles 110 and a computing unit 100 for explaining the present invention. The computing unit 100 can, for example, be a server, possibly also for a so-called cloud, which serves as an evaluation site or evaluation system.

The vehicles are vehicles moving in an at least partially automated manner, e.g., so-called autonomous vehicles. They may be part of a vehicle fleet and may be designed identically or similarly. It is understood that in practice there will be significantly more vehicles.

One of the vehicles 110 is also shown enlarged, by way of example. This vehicle comprises a computing unit 112 designed as a control unit, as well as a sensor 114, by way of example. For example, the computing unit 112 may read data from the sensor 114 and may also exchange data with the computing unit 100 and/or other communication units via a communication module not shown. It is understood that the vehicle may comprise further sensors and/or control units. Likewise, the other vehicles 110 have such a control unit and sensors. Furthermore, persons 120, e.g., developers, are illustrated by way of example.

A plurality of scenarios 126, trigger events 122, and safety metrics 124 can be stored in each of the vehicles. This may be done, for example, by developers 120. The trigger events and the scenarios can, for example, be transmitted to or implemented in the vehicles 110 so that the vehicles can check whether the conditions thereof are fulfilled. The safety metrics 124 can also be defined along with suitable threshold values or states. This may also be done by developers 120, for example. The safety metrics with the threshold values or states can be transmitted to or implemented in the vehicles 110 so that the vehicles can check whether the threshold values are exceeded or fallen below or whether the states are fulfilled.

Some possible safety metrics are shown below by way of example, viz., also whether it is a safety metric with the first metric (type 1), i.e., a continuous safety metric, or a safety metric with the second metric (type 2), i.e., a Boolean safety metric.

| Safety metric | Type |
|---|---|
| Fallback level activated | 2 |
| Brake threat number (BTN) | 1 |
| Time to collision (TTC) | 1 |
| Deviation of speed/distance | 1 |
| Object recognition or classification | 1 |
| delay/object lost | |
| Unexpected object recognized | 2 |
| Activation of an autonomous driving | 2 |
| function outside ODD | |
| Safe trajectory | 1 |
| Localization error | 2 |
| Error in a redundant processing path | 2 |
| Near-miss event (e.g., a “near” fault, | 2 |
| i.e., the case that a continuous safety | |
| metric is, for example, just below the | |
| response threshold) | |

Entries 122, 124, each with a plurality of data records of a particular scenario, can also be stored in the computing unit 100 or a database connected thereto.

FIG. 2 schematically shows a sequence of a method according to the present invention in a preferred embodiment. With reference to FIG. 1, this exemplary sequence is to be explained below.

In a step 200, it is checked in a vehicle 110 whether a safety metric is fulfilled. The sensors 114 may be used for this purpose, for example. This is in particular true for each vehicle 110. In particular, all existing safety metrics are continuously checked as to whether they are fulfilled. If a safety metric is fulfilled, the scenario present in this case or at that time point can be determined and recorded, as well as all values for the safety metrics relevant to the scenario, including the fulfilled safety metric.

In a step 210, the scenario (as scenario information 132) and the safety metric information 134 with all values for the safety metrics relevant to the scenario are transmitted to the computing unit 100 and, in step 220, received or obtained there. Steps 200 and, where applicable, 210 can in particular be carried out continuously and during the operation of the vehicles 110. It is understood that in a large vehicle fleet, not all vehicles are continuously in operation. Rather, each vehicle can perform the steps when it is in operation.

The scenario information 132, here the scenario, comprises, for example, current values of road type, speed, time of day, and weather. Two examples of scenarios are shown below.

| Scenario | |
|---|---|
| A | Highway, day, sun, speed >120 km/h |
| B | Highway, night, rain, speed >120 km/h |

In a step 230, it is then checked in the server 100 whether the scenario obtained and present at that time point has already been stored. If this is not the case (N), the scenario present at that time point and the safety metric information will be stored in step 232, i.e., a new entry similar to 142, 144 will be created. If the scenario has already been stored (Y), i.e., e.g., the scenario can be assigned to entry 142 or 144, this scenario is, for example, retrieved in step 234. A statistic of the scenario present at that time point and already stored can be updated, i.e., the newly obtained safety metric information can be added as a new data record to the corresponding entry.

In step 240, a relevance distribution of the safety metrics (SPI) of the scenario present at that time point is then determined. The relevance distribution indicates how often a respective safety metric is or has been fulfilled in this scenario.

Two entries for two scenarios, e.g., scenarios A (first table) and B (second table) as mentioned above, which comprise a plurality of data records (DS) with respective safety metric information, are shown below by way of example; a corresponding relevance distribution (RV) is also shown.

| SPI | DS1 | DS2 | DS3 | DS4 | RV |
|---|---|---|---|---|---|
| TTC < 0.4 s | 0.3 | 0.6 | 0.2 | 0.2 | 75% |
| Fallback | No | No | No | Yes | 25% |
| level | | | | | |
| activated | | | | | |
| BTN > 20 | 10 | 23 | 15 | 40 | 50% |
| TTC < 0.4 s | 0.3 | 0.6 | 0.2 | 0.2 | 75% |
| BTN > 20 | 23 | 10 | 40 | 15 | 50% |

For example, if the safety metric TTC (time to collision) is the one that is currently fulfilled, and scenario A is currently present, a relevance distribution of 75% results. In other words, the safety metric TTC is fulfilled in 75% of cases in which scenario A satisfies any (at least one) safety metric.

In step 250, this particular relevance distribution is now compared to relevance distributions of at least one already existing scenario for which a trigger event is defined. For example, whereas a trigger event has not yet been defined for scenario A, a trigger event is defined for scenario B, for example. Thus, for example, the relevance distribution of 75% for the safety metric TTC is compared to the relevance distribution for the safety metric TTC in scenario B.

For example, the relevance distribution for safety metric TTC is likewise 75% there, both relevance distribution thus even match. This allows the conclusion that scenario A could also represent a potential trigger event. In step 260, scenario A is thus determined to be a potential trigger event and, in step 262, information about it is provided. If a new trigger event is defined, it can also be stored in the vehicles. If no matching relevance distribution is found, the method can be started from the beginning, step 264, i.e., the data collection can be continued.

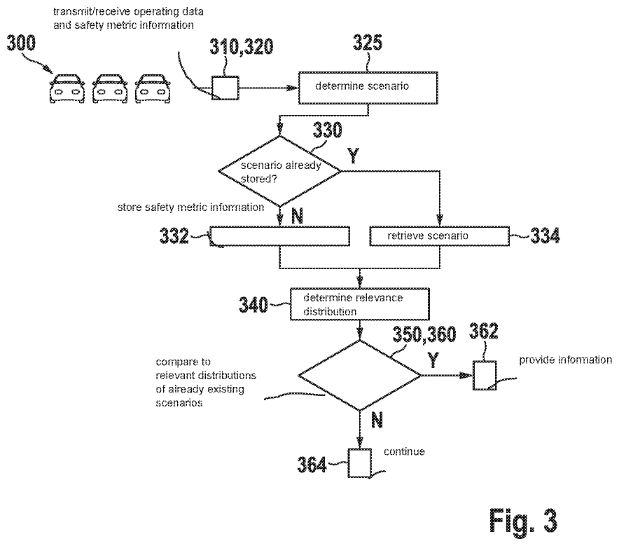

FIG. 3 schematically shows a sequence of a method according to the present invention in a further, preferred embodiment. With reference to FIG. 1, this exemplary sequence is to be explained below.

In a step 300, it is checked in a vehicle 110 whether a safety metric is fulfilled. The sensors 114 may be used for this purpose, for example. This is in particular true for each vehicle 110. In particular, all existing safety metrics are continuously checked as to whether they are fulfilled. If a safety metric is fulfilled, the scenario present in this case or at that time point or, for example, the operating data of the vehicle in this case can be determined and recorded, as well as all values for the safety metrics relevant to the scenario, including the fulfilled safety metric.

In a step 310, the operating data of the vehicle (as scenario information 132) and the safety metric information 134 with all values for the safety metrics relevant to the scenario are transmitted to the computing unit 100 and, in step 220, received or obtained there. Steps 300 and, where applicable, 310 can in particular be carried out continuously and during the operation of the vehicles 110. It is understood that in a large vehicle fleet, not all vehicles are continuously in operation. Rather, each vehicle can perform the steps when it is in operation.

In step 325, the scenario is then determined based on the operating data. This can, for example, take place with higher computing power and/or better algorithms, possibly also further additional information, than in the vehicle itself. This step can be parameterized, for example, to take into account more or less individual items of scenario information on the same scenario from the vehicle fleet, e.g., by approximating the geographic position or the number and position of surrounding objects.

The further course then corresponds to the procedure according to FIG. 2, i.e., steps 330 to 364 correspond to steps 230 to 264, so that reference can be made to the description there.

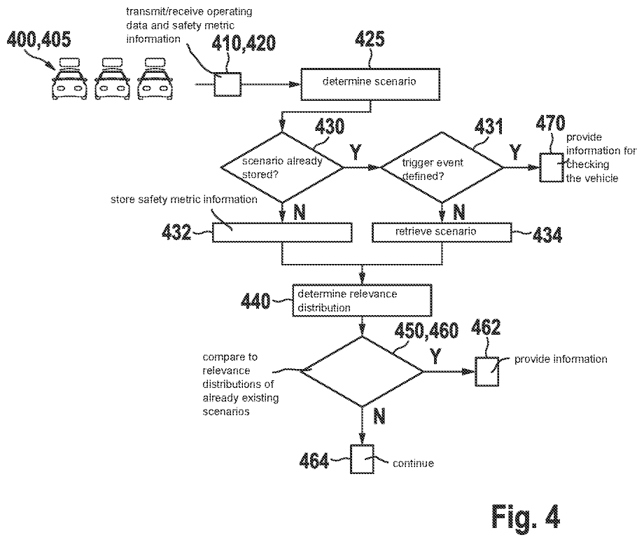

FIG. 4 schematically shows a sequence of a method according to the present invention in a further, preferred embodiment. With reference to FIG. 1, this exemplary sequence is to be explained below.

In a step 400, it is checked in a vehicle 110 whether a safety metric is fulfilled. The sensors 114 may be used for this purpose, for example. This is in particular true for each vehicle 110. In particular, all existing safety metrics are continuously checked as to whether they are fulfilled. If a safety metric is fulfilled, the scenario present in this case or at that time point is determined and, unlike, e.g., in the sequence according to FIG. 2 or 3, it can be checked in step 405 whether a trigger event has already been defined for the scenario present at that time point. A list with all trigger events can be stored in the vehicle for this purpose. If this is not the case, the scenario present at that time point or, for example, the operating data of the vehicle in this case, are recorded, as are all values for the safety metrics relevant to the scenario, including the fulfilled safety metric.

In a step 410, the operating data of the vehicle (as scenario information 132) as well as the safety metric information 134 with all the values for the safety metrics relevant to the scenario are transmitted to the computing unit 100 and, in step 420, received or obtained there. Steps 400 and, where applicable, 405, 410 can in particular be carried out continuously and during the operation of the vehicles 110. It is understood that in a large vehicle fleet, not all vehicles are continuously in operation. Rather, each vehicle can perform the steps when it is in operation.

In step 425, the scenario is then determined based on the operating data. This can, for example, take place with higher computing power and/or better algorithms, possibly also further additional information, than in the vehicle itself. This step can be parameterized, for example, to take into account more or less individual items of scenario information on the same scenario from the vehicle fleet, e.g., by approximating the geographic position or the number and position of surrounding objects.

In a step 430, it is then checked in the server 100 whether the scenario thus determined and present at that time point has already been stored. If this is not the case (N), the scenario present at that time point and the safety metric information will be stored in step 432, i.e., a new entry similar to 142, 144 will be created. If the scenario has already been stored (Y), i.e., e.g., the scenario can be assigned to entry 142 or 144, it is checked in step 431 whether a trigger event has already been defined for this scenario. If this is the case (Y), information for checking the vehicle is provided in step 470 since this is an indication that a fault exists in the vehicle.

If this is not the case (N), this scenario is, for example, retrieved in step 434. A statistic of the scenario present at that time point and already stored can be updated, i.e., the newly obtained safety metric information can be added as a new data record to the corresponding entry.

The further course then corresponds to the procedure according to FIG. 2, i.e., steps 440 to 464 correspond to steps 240 to 264, so that reference can be made to the description there.

1-14. (canceled)

15. A method for improving safety precautions for vehicles moving in an at least partially automated manner, based on trigger events and safety metrics, wherein a scenario includes values for one or more vehicle and/or environmental parameters, wherein a trigger event defines one or more predetermined conditions for a scenario, and wherein a safety metric:
defines a metric that, in a vehicle moving in an at least partially automated manner, during operation of the vehicle, determines values for one or more vehicle and/or environmental parameters and compares them to one or more threshold values, wherein the safety metric is deemed to be fulfilled when at least one of the values of the first metric exceeds or falls below the one or at least one of the plurality of threshold values, or
defines a second metric that checks whether one or more predetermined states exist, wherein the safety metric is deemed to be fulfilled if the one or at least one of the plurality of predetermined states exists,
the method comprising the following steps:
obtaining, from each respective vehicle of at least one vehicle moving in an at least partially automated manner, when a safety metric is fulfilled at a time point in the vehicle: i) scenario information characterizing a scenario present at the time point, and ii) safety metric information including current information on the fulfilled safety metric, regarding at least the scenario present at the time point;
determining a relevance distribution of the safety metric of the scenario present at the time, wherein the relevance distribution indicates how often the safety metric is or has been fulfilled in the scenario;
comparing the determined relevance distribution to relevance distributions of existing scenarios for which a trigger event is defined;
determining the scenario present at that time point to be a potential trigger event when the relevance distribution of the scenario present at that time point matches, within predetermined limits, a relevance distribution of at least one already existing scenario for which a trigger event is defined; and
providing information about the potential trigger event.

16. The method according to claim 15, further comprising: automatically adding new trigger events to a database for future testing of vehicles moving in an at least partially automated manner.

17. The method according to claim 15, wherein the scenario information characterizing the scenario present at that time point includes the scenario.

18. The method according to claim 15, wherein the scenario information characterizing the scenario present at the time point includes operating data of the vehicle present and/or detected at the time point, and wherein the scenario present at the time point is determined at least partially based on the operating data.

19. The method according to claim 18, wherein the operating data includes at least one of the following:
the current sensor data including a recorded video or radar data, for at least one sensor of the vehicle, and
internal states of the vehicle including a recognized environment.

20. The method according to claim 15, further comprising, after obtaining the scenario information and prior to determining the relevance distribution:
checking whether the scenario present at that time point has already been stored, and, when the scenario present has not already been stored, storing the scenario present at that time point and the safety metric information, and/or when the scenario present has already been stored, updating a statistic of the scenario present at that time point and already stored.

21. The method according to claim 15, furthermore comprising, after obtaining the scenario information and prior to determining the relevance distribution:
checking whether a trigger event for the scenario present at that time point has already been defined, and,
when a trigger event for the scenario present at that time point has already been defined, providing the information obtained from the vehicle to check the vehicle.

22. The method according to claim 21, furthermore comprising, when a trigger event for the scenario present at that time point has already been defined, automatically bringing the vehicle into a safe state.

23. A method for improving safety precautions for vehicles moving in an at least partially automated manner, based on trigger events and safety metrics, wherein a scenario include values for one or more vehicle and/or environmental parameters, wherein a trigger event defines one or more predetermined conditions for a scenario, and wherein a safety metric:
defines a metric that, in a vehicle moving in an at least partially automated manner, during operation of the vehicle, determines values for one or more vehicle and/or environmental parameters and compares them to one or more threshold values, wherein the safety metric is deemed to be fulfilled when at least one of the values of the first metric exceeds or falls below the one or at least one of the plurality of threshold values, or
defines a second metric that checks whether one or more predetermined states exist, wherein the safety metric is deemed to be fulfilled when the one or at least one of the plurality of predetermined states exists,
the method comprising the following steps:
checking, in a vehicle moving in an at least partially automated manner, whether a safety metric is fulfilled; and
transmitting to an evaluation system, when a safety metric is fulfilled at a time point in the vehicle:
scenario information characterizing a scenario present at the time point; and
safety metric information including current information on the fulfilled safety metric regarding at least the scenario present at the time point.

24. The method according to claim 23, further comprising, prior to transmitting:
checking whether a trigger event for the scenario present at that time point has already been defined,
wherein, when a trigger event has already been defined for the scenario present at that time point, the transmission will not take place.

25. The method according to claim 15, wherein a scenario includes values of one or more of the following vehicle and/or environmental parameters: road type, speed, position, time of day, weather, recognized objects.

26. A computing unit configured to improve safety precautions for vehicles moving in an at least partially automated manner, based on trigger events and safety metrics, wherein a scenario includes values for one or more vehicle and/or environmental parameters, wherein a trigger event defines one or more predetermined conditions for a scenario, and wherein a safety metric:
defines a metric that, in a vehicle moving in an at least partially automated manner, during operation of the vehicle, determines values for one or more vehicle and/or environmental parameters and compares them to one or more threshold values, wherein the safety metric is deemed to be fulfilled when at least one of the values of the first metric exceeds or falls below the one or at least one of the plurality of threshold values, or
defines a second metric that checks whether one or more predetermined states exist, wherein the safety metric is deemed to be fulfilled if the one or at least one of the plurality of predetermined states exists,
the computing unit configured to:
obtain, from each respective vehicle of at least one vehicle moving in an at least partially automated manner, when a safety metric is fulfilled at a time point in the vehicle: i) scenario information characterizing a scenario present at the time point, and ii) safety metric information including current information on the fulfilled safety metric, regarding at least the scenario present at the time point;
determine a relevance distribution of the safety metric of the scenario present at the time, wherein the relevance distribution indicates how often the safety metric is or has been fulfilled in the scenario;
compare the determined relevance distribution to relevance distributions of existing scenarios for which a trigger event is defined;
determine the scenario present at that time point to be a potential trigger event when the relevance distribution of the scenario present at that time point matches, within predetermined limits, a relevance distribution of at least one already existing scenario for which a trigger event is defined; and
provide information about the potential trigger event.

27. A non-transitory machine-readable storage medium on which is stored a computer program for improving safety precautions for vehicles moving in an at least partially automated manner, based on trigger events and safety metrics, wherein a scenario includes values for one or more vehicle and/or environmental parameters, wherein a trigger event defines one or more predetermined conditions for a scenario, and wherein a safety metric:
defines a metric that, in a vehicle moving in an at least partially automated manner, during operation of the vehicle, determines values for one or more vehicle and/or environmental parameters and compares them to one or more threshold values, wherein the safety metric is deemed to be fulfilled when at least one of the values of the first metric exceeds or falls below the one or at least one of the plurality of threshold values, or
defines a second metric that checks whether one or more predetermined states exist, wherein the safety metric is deemed to be fulfilled if the one or at least one of the plurality of predetermined states exists,
the computer program, when executed by a computer, causing the computer to perform the following steps:
obtaining, from each respective vehicle of at least one vehicle moving in an at least partially automated manner, when a safety metric is fulfilled at a time point in the vehicle: i) scenario information characterizing a scenario present at the time point, and ii) safety metric information including current information on the fulfilled safety metric, regarding at least the scenario present at the time point;
determining a relevance distribution of the safety metric of the scenario present at the time, wherein the relevance distribution indicates how often the safety metric is or has been fulfilled in the scenario;
comparing the determined relevance distribution to relevance distributions of existing scenarios for which a trigger event is defined;
determining the scenario present at that time point to be a potential trigger event when the relevance distribution of the scenario present at that time point matches, within predetermined limits, a relevance distribution of at least one already existing scenario for which a trigger event is defined; and
providing information about the potential trigger event.
